(19) United States
(12) Patent Application Publication
(10) Pub. No.: US 2007/0048471 A1
(43) Pub. Date: Mar. 1, 2007

(54) Laminated fuel tank using high-barrier material

(75) Inventors: Shoji Satoh, Tochigi (JP); Tohru Matsuzaki, Tochigi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YACHIYO KOGYO KABUSHIKI KAISYA, Sayama-shi (JP)

(21) Appl. No.: 11/208,546

(22) Filed: Aug. 23, 2005

(51) Int. Cl. B32B 27/08

(52) U.S. Cl. 428/35.7

(57) ABSTRACT

An aspect of the present invention is any of a vehicle fuel tank and its member molded with a laminated body of one or more kinds of resins, the laminated body comprising a barrier layer composed of an ethylene-vinyl alcohol copolymer, wherein an ethylene containment amount is 20 to 25 mol %; and an outer layer and inner layer that are molded with a thermoplastic resin other than the ethylene-vinyl alcohol copolymer and provided at both faces of the barrier layer, wherein the inner layer is located at a side contacting fuel or evaporated fuel, and a thickness of the barrier layer is 2.0 to 5.0% of a total sum of the inner layer, the outer layer, and the barrier layer.

### BACKGROUND OF THE INVENTION

1. Field of the Invention

The present invention relates to any of a fuel tank and its member that can reduce a permeation amount of hydrocarbons of a fuel tank than a current one without damaging an impact strength thereof.

2. Description of the Related Art

In recent years from an environmental protection viewpoint is desired a vehicle where a permeation amount of hydrocarbons (fuel) is less, and a legal regulation thereof is also provided. Because a main source of an emission of the hydrocarbons from the vehicle is a fuel tank, the tank whose permeation amount of the hydrocarbons is less is desired.

As a fuel tank that effectively reduces the permeation amount of the hydrocarbons is known the tank of a configuration of using an ethylene-vinyl alcohol copolymer (hereinafter referred to as EVOH) resin as a barrier layer and making a laminated body together with a high density polyethylene (hereinafter referred to as HDPE) resin (see JPA 2001-97053, U.S. Pat. No. 6,737,132).

Although current legal regulations are achieved by such a fuel tank, a further reduction of the permeation amount of the hydrocarbons is requested. The tank using the above EVOH and HDPE is thought to be a system adequate for achieving the purpose.

In this connection, the permeation amount of the hydrocarbons can be reduced by reducing an ethylene containment amount in the EVOH. On the other hand, because polyvinyl alcohol is remarkably low in impact strength under a low temperature and humidity, it is known that a container is apt to break (see paragraph 0003 of JPA Hei. 9-328581 by KURARAY CO., LTD, U.S. Pat. No. 5,792,809). Accordingly, if reducing the ethylene containment amount in the EVOH, there can occur another technical problem that the impact strength of the fuel tank lowers and becomes apt to break. Therefore, in a fuel tank composed of the laminated body of the EVOH and the HDPE, a target of reducing the permeation amount of the hydrocarbons of the fuel tank than a current one has not been achieved without damaging an impact strength thereof.

Consequently, it is strongly requested any of a fuel tank and its member that can reduce the permeation amount of the hydrocarbons of the tank than a current one without damaging an impact strength thereof.

### SUMMARY OF THE INVENTION

An aspect of the present invention is any of a vehicle fuel tank and its member molded with a laminated body of one or more kinds of resins, the laminated body comprising a barrier layer composed of an EVOH, wherein an ethylene containment amount is 20 to 25 mol %; and an outer layer and inner layer that are molded with a thermoplastic resin other than the EVOH and provided at both faces of the barrier layer, wherein the inner layer is located at a side contacting fuel or evaporated fuel, and a thickness of the barrier layer is 2.0 to 5.0% of a total sum of the inner layer, the outer layer, and the barrier layer.

In another aspect a melt flow rate (MFR, under a condition of 190 degrees Celsius and 2,160 g load, based on JIS K 7210) of the EVOH is 0.1 to 10 g/10 min.

In another aspect the thermoplastic resin is a high density polyethylene.

In another aspect an adhesive resin layer is provided between the barrier layer and the inner layer and between the barrier layer and the outer layer.

In another aspect a tensile impact strength (hereinafter referred to as TIS) of any of the fuel tank and its member at −40 degrees Celsius is not less than 50 kJ/m².

In another aspect a thickness of the barrier layer is not less than 120 μm.

In another aspect a gasoline permeation amount of any of the fuel tank and its member is not more than 2.0 mg/day.

### DESCRIPTION OF THE PREFERRED EMBODIMENTS

Inventors of the present invention have discovered that if lowering a ethylene containment amount in an EVOH, a permeation coefficient of hydrocarbons lowers; whereas the TIS does not almost change in a lower ethylene containment amount region, and thus have resulted in completing the present invention by using the EVOH, whose ethylene containment amount is less than a conventional one, for a barrier layer and making a thickness of an EVOH layer in a multilayer structure within a range of a definite ratio.

Hereafter will be described an embodiment of the present invention, making it an example a fuel tank made of plastics comprising an inner layer and an outer layer composed of a thermoplastic resin at both faces of the barrier layer. Such a fuel tank can be manufactured by a multilayer blow molding using a co-extrusion die.

The barrier layer used in the fuel tank of the present invention is molded with an ethylene-vinyl alcohol copolymer (EVOH) of a resin having a barrier property (liquid and gas barrier property) for vehicle fuel. A gasoline permeation amount of the EVOH is about one millionth of a polyolefin such as polypropylene and the HDPE.

The EVOH of the present invention is obtained by saponifying a copolymer of a vinyl ester and ethylene, using an alkali catalyst and the like. As the vinyl ester can be used vinyl acetate, vinyl propionate, and the like.

In addition, a degree of saponification of the vinyl ester component of the EVOH used in the present invention is preferably not less than 90 mol %, and most preferably not less than 99 mol %. If the degree of saponification is less than 90 mol %, a gas barrier property under higher humidity lowers, a thermal stability deteriorates, and gel and a fish eye are apt to occur in a molded product.

The ethylene containment amount of the EVOH is preferably 20 to 25 mol %. In a lower region of the ethylene containment amount, because the gas barrier property under a higher humidity lowers and a melt forming property also deteriorates, the ethylene containment amount is preferably not less than 20 mol %. In addition, in a higher region of the ethylene containment amount, because a sufficient gas barrier property is not obtained, the ethylene containment amount is preferably not more than 25 mol %. The ethylene containment amount in the EVOH (hereinafter referred to as ethylene containment amount) can be derived by a nuclear magnetic resonance (NMR) method.

In addition, a small amount of other monomers can be polymerized into the EVOH in a range of not obstructing the purpose of the present invention. As examples of the monomers that can be polymerized can be cited α-olefin such as 1-butene, isobutene, 4-methy-1-pentene, 1-hexene, and 1-octene; unsaturated carboxylic acid such as methacrylic acid, acrylic acid, and maleic anhydride, salt thereof, and partial ester or complete ester thereof, anhydride thereof; vinyl silane compounds such as vinyl trimethoxy silane; and the like.

In addition, in the EVOH can be contained an additive such as boron compounds, alkali metal salt, and phosphate compounds.

By containing the EVOH in a boron compound, a melt viscosity and thermal stability of the EVOH are improved and thus a uniform co-extrusion body can be stably obtained. Here, as a born compound can be cited boric acid, boric acid ester, boric acid salt, boron hydride, and the like, and for example, the boric acid can be used. The containment amount of the boron compound can be selected in a range of 20 to 2,000 ppm converted to the boron element. Thus the EVOH whose torque variations of an extruder in heating/melting are suppressed can be obtained. In less than 20 ppm such an effect is smaller; over 2,000 ppm the EVOH is apt to become gel, causing a molding defect in some case.

In addition, by containing alkali metal salt by 5 to 500 ppm converted to the alkali metal element for the EVOH of the present invention, an adhesive ability between layers, and a mutual solubility can be improved. The containment amount of the alkali metal salt can be selected in a range of 20 to 1,000 ppm converted to the alkali metal element. Here, as the alkali metal can be cited sodium, potassium, and the like; as the alkali metal salt can be used sodium acetate, potassium acetate, and sodium phosphate.

In addition, by adding a phosphate compound to the EVOH of the present invention in an adequate range can be suppressed a coloring of a molded product and an occurrence of gel and a fish eye. As a phosphate compound can be used, for example, sodium dihydrogen phosphate and potassium dihydrogen phosphate. The containment amount of the phosphate compound can be selected in a range of 70 to 300 ppm. In a case of recycling and using an end material of a resin occurring by pinch-off in blow molding, the coloring of the molded product and the occurrence of gel and a fish eye can be effectively prevented by adding the phosphate compound to the EVOH in an adequate range.

In addition, other resins such as a thermal stabilizer, ultraviolet ray absorption agent, oxidation preventive agent, filler, polyamide, and polyolefin can also be blended in an EVOH resin.

The EVOH used in the present invention can be selected within a range of 0.1 to 10 g/10 min of the melt flow rate (MFR) (under a condition of 190 degrees Celsius and 2,160 g load, based on JIS K 7210)

As a thermoplastic resin used as inner and outer layers in the present invention can be cited a single polymer or copolymer of an olefin such as a linear low density polyethylene, middle density polyethylene, high density polyethylene, ethylene-propylene copolymer, polypropylene, and polybutene; a polyamide resin such as Nylon-6 and Nylon-6, 6; polystyrene; polycarbonate; and the like.

In a case that the fuel tank of the present invention is an automobile gasoline tank, a high density polyethylene can be used as the thermoplastic resin. The high density polyethylene can be used, appropriately selected from among usual commercial products. From a viewpoint of such a rigidity, an anti-impact property, a formability, an anti-drawdown property, and an anti-gasoline property, a density of the high density polyethylene can be used, selected from a range of 0.96 to 0.98 g/cm³. In addition, the MFR of the high density polyethylene can be used, selected from a range of 0.1 to 10 g/10 min (under a condition of 190 degrees Celsius and 2,160 g load, based on JIS K 7210).

In addition, in the fuel tank of the present invention the inner and outer layers can be laminated on both faces of a barrier layer (EVOH) through an adhesive resin layer composed of a carboxylic modified polyolefin. The carboxylic modified polyolefin means a copolymer composed of α-olefin and unsaturated carboxylic acid or its anhydride, and also includes one where polyolefin having a carboxylic group in its molecule and all or part of the carboxylic group contained in the polyolefin exists in form of metal salt. As a polyolefin that becomes a base of the carboxylic modified polyolefin, for example, linear low density polyethylene and ethylene-vinyl acetate can be used.

As an unsaturated carboxylic acid can be exemplified acrylic acid, methacrylic acid, maleic acid, maleic acid monomethyl, maleic acid monoethyl, and the acrylic acid and the methacrylic acid are specifically preferable. The containment amount of the unsaturated carboxylic acid is 3 to 12 mol %. As an unsaturated carboxylic anhydride are exemplified itaconic anhydride, maleic anhydride, and the like. The containment amount of the unsaturated carboxylic anhydride is from 0.001 to 5 mol %.

As a metal ion in the metal salt of the carboxylic modified polyolefin are exemplified alkali metals such as sodium and potassium and alkali earth metals such as magnesium and calcium. A neutralization degree in the metal salt of the carboxylic modified polyolefin can be selected in a range of 30 to 70%.

The MFR of the carboxylic modified polyolefin can be selected in a range of 0.1 to 50 g/10 min (under a condition of 190 degrees Celsius and 2,160 g load. Each of these carboxylic modified polyolefins can be used independently or by blending one or more kinds thereof.

There is no limitation in a molding method of the fuel tank of the present invention and, for example, the tank can be manufactured by known multilayer blow molding such one as described in U.S. Pat. No. 6,737,132. Also in a case of laminating inner and outer layers on both faces of the barrier layer through an adhesive resin, the tank can be molded by any of blow molding and co-extrusion pipe molding methods, using a known co-extrusion die.

Meanwhile, because the EVOH used in the present invention whose ethylene containment amount is 20 to 25 mol % is higher in melting point by around 10 degrees Celsius than a conventional EVOH of the ethylene containment amount of 30 to 40 mol %, it is preferable to also set a processing temperature in the blow molding around 10 degrees Celsius higher.

A ratio of a thickness of an EVOH layer to a whole of the laminated body (hereinafter referred to as EVOH thickness ratio) can be adjusted by a lip opening of the co-extrusion die. Although a setting value of the lip opening of the co-extrusion die and an actually measured value of a thickness of a laminated resin are usually different, the thickness of the EVOH layer can be controlled in a range of the present invention by clarifying a relationship thereof through an experiment in advance. A deviation between the setting value and the actually measured value is influenced by a form of a co-extrusion die used, a processing temperature, and the like.

It is preferable to perform the molding so that the thickness of the EVOH layer becomes not less than 120 μm. In order to make the thickness of the EVOH layer smaller than 120 μm, although it is necessary to make the lip opening of the co-extrusion die smaller or a blow-up ratio larger, the blow molding becomes difficult in each case, and a defect ratio of the product becomes higher.

In addition, a metal mold temperature in molding the fuel tank of the present invention is preferably 5 to 30 degrees Celsius. In a case that the metal mold temperature is less than 5 degrees Celsius, a dew is apt to form on a metal surface and there is a possibility that an appearance of the product after molded becomes defective. In addition, in a case that the metal mold temperature exceeds 30 degrees Celsius, there is a possibility that productivity lowers because a cooling time of the resin becomes longer; in a case that the resin cannot be sufficiently cooled, there is a possibility that a strain occurs in a shape of a co-extrusion blow molding product after the molding.

When molding a co-extrusion blow molding tank, it is inevitable that an end material of a resin occurs by pinch-off. It is possible to remelt the end material of such a resin and a rejected product in molding and to use them as a recycle material layer. Thus by using them as the recycle material layer, it is possible to reduce a loss of the resin used in molding and processing the tank. After a multilayer structure body composed of the thermoplastic resin and the barrier layer (and the adhesive resin, depending on an embodiment) is remelted, the recycle material layer is molded with it, and in many cases, generally becomes weaker in mechanical strength than a layer composed of a single thermoplastic resin. In a case that the tank receives impact from outside, because a stress for the impact works at the tank inner layer, causes a strain in the tank, and thus a breakage occurs in some case, it is preferable to dispose the recycle material layer, which is weak in strength, at an outer layer side.

In addition, in accordance with the present invention can also be molded not only a shell of a fuel tank but also a member of the tank whose impact strength is equivalent to a conventional tank and whose permeation amount of hydrocarbons is reduced more than the conventional one, for example, a pipe inserted in the fuel tank, a joint member between the fuel tank and the pipe, a cap of the fuel tank, and the like. These members can be molded by a multilayer co-extrusion molding method and a multilayer injection molding method. Otherwise, laminating each resin molded into a sheet form in advance, these members can also be formed by press forming and vacuum forming.

### EXAMPLE

Although hereafter the present invention is further described, it is not limited thereby. Meanwhile, a gasoline permeation amount and drop impact strength of each example are measured according to methods below.

### Example 1

In example 1, as a barrier layer was used an EVOH whose ethylene containment amount was 24 mol %, a degree of saponification was 99.5 mol %, the MFR was 2.2 g/10 min (210 degrees Celsius, 2,160 g load). As a high density polyethylene (HDPE) was used HB112R (density=0.946 g/cm³; MFR=6.0 g/10 min [210 degrees Celsius, 2,160 g load]) manufactured by Japan Polyethylene Corp; as an adhesive resin is used modified polyethylene FT-71A (MFR=0.7 g/10 min [210 degrees Celsius, 2,160 g load]) manufactured by Japan Polyethylene Corp.

Having made a thickness of about 90 μm of an HDPE film, a thickness of about 10 μm of an adhesive resin film, and a thickness of about 20 μm of an EVOH film by extrusion molding and having used these films, a sheet of a resin laminated body of a configuration composed of HDPE layer (90) /adhesive layer (10)/barrier layer (20)/adhesive layer (10)/HDPE layer (90 μm) was molded.

### Example 2

As a barrier layer was used the EVOH whose ethylene containment amount was 20 mol %, the degree of saponification was 99.5 mol %, the MFR was 3.0 g/10 min (210 degrees Celsius, 2,160 g load).

Having used the same HDPE and adhesive resin as in the example 1 other than this, a sheet of a resin laminated body of the same layer structure and layer thickness was molded.

### Comparison Example 1

As a barrier layer was used the EVOH whose ethylene containment amount was 26 mol %, the degree of saponification was 99.5 mol %, the MFR was 3.9 g/10 min (210 degrees Celsius, 2,160 g load).

Having used the same HDPE and adhesive resin as in the example 1 other than this, a sheet of a resin laminated body of the same layer structure and layer thickness was molded.

With respect to the examples 1 and 2 and the comparison example 1 were measured each gasoline permeation rate and TIS. A result is shown in Table 1.

Meanwhile, the gasoline permeation rate and TIS were derived as follows.

<Gasoline Permeation Rate>

As model fuel was used a mixture of 45 vol. % of isooctane, 45 vol. % of toluene, and 10 vol. % of ethanol.

Having made the sheet of the resin laminated body pinched at center of a glass container dividable into ups and downs, those of the glass container were partitioned. Next, the model fuel was filled in the upper chamber of the glass container, and an inert gas adjusted at 40 degrees Celsius and 65% RH was passed for a predetermined time. Then by gas chromatography was continuously measured a concentration of the model fuel that permeated the sheet of the resin laminated body and diffused into the inert gas.

A gasoline permeation rate (g·20 μm/m²/day) was calculated from an integrated value (g) of the model fuel having permeated the sheet of the resin laminated body, a permeation area (m²) of the model fuel, and a measurement time (day).

In addition, the TIS was measured as follows.

<TIS>

Having punched out a test piece for measuring the TIS from the sheet of the resin laminated body, the TIS was measured at −40 degrees Celsius according to ASTMD 1822.

TABLE 1

| | Ethylene Containment | | |
|---|---|---|---|
| | Amount in EVOH | Gasoline Permeation | TIS |
| | (mol %) | Rate (g · 20 μm/m²/day) | (kJ/m²) |
| Example 1 | 24 | 1.1 | 218 |
| Example 2 | 20 | 0.5 | 217 |
| Comparison | 26 | 2.0 | 227 |
| Example 1 | | | |

As shown in Table 1, although the gasoline permeation rate in 26 mol %, which is out of the range of the ethylene containment amount of the present invention, is 2.0 (g·20 μm/m²/day), it rapidly lowers as the ethylene containment amount lowers. On the contrary, the TIS does not almost change even if the ethylene containment amount lowers. Such a correlation between the gasoline permeation rate and the TIS is not known heretofore.

In examples 3 to 5 and comparison example 2 below, by having adjusted the lip opening of the co-extrusion die of a multilayer blow molding machine for an actual automobile gasoline tank shell, a fuel tank shell of a different thickness of the EVOH layer was molded, and then the gasoline permeation rate and impact strength were measured.

As an extruder of the multilayer blow molding machine was used KBS2-242-150 type manufactured by The Japan Steel Works, LTD: a maximum temperature of a cylinder of the EVOH extruder was set to 220 degrees Celsius; a temperature of the co-extrusion die was set to 215 degrees Celsius. Then was molded a fuel tank shell of 500 ml of four kinds and seven layers of HDPE/adhesive/EVOH/adhesive/recycle material/HDPE. Here, the recycle material means a resin constituent composed of 40 wt % of an end material, which occurs in blow molding, and 60 wt % of the HDPE (HB112R).

### Example 3

In example 3, as a barrier layer was used the EVOH whose ethylene containment amount was 24 mol %, the degree of saponification was 99.5 mol %, the MFR was 2.2 g/10 min (210 degrees Celsius, 2,160 g load); and as an HDPE and an adhesive resin were used the same things as in the example 1. Then having made it 2.5% a target value of the EVOH thickness ratio and having set the lip opening of the extrusion die, a fuel tank shell was molded by blow molding.

### Example 4

Having set the lip opening of the extrusion die 3.2% in the EVOH thickness ratio, a fuel tank shell was molded by the same condition as in the example 3 other than this. In other words, the EVOH of an ethylene containment amount off 24 mol % was used.

### Example 5

Having set the lip opening of the extrusion die 4.5% in the EVOH thickness ratio, a fuel tank shell was molded by the same condition as in the example 3 other than this. In other words, the EVOH of an ethylene containment amount of 24 mol % was used.

### Comparison Example 2

Having used the EVOH of an ethylene containment amount of 26 mol % and having set the lip opening of the extrusion die 2.5% in the EVOH thickness ratio, a fuel tank shell was molded by the same condition as in the example 3 other than this.

With respect to the examples 3 to 5 and the comparison example 2, as below, were measured or performed a gasoline permeation amount, a low temperature drop test, the TIS, and a layer thickness of each resin.

<Gasoline Permeation Amount>

After having attached a member such as a valve for filling fuel to a molded fuel tank shell, model fuel composed of 45 vol. % of isooctane, 45 vol. % of toluene, and 10 vol. % of ethanol was filled till 40 vol. % of a nominal volume of the fuel tank.

Then based on a DBL (Diurnal Breathing Loss) of the CABR (California Air Resources Board), a gasoline permeation amount (g/day) was derived.

In more detail, the model fuel tank was put in a SHED (Sealed Housing for Evaporation Determination) filled with the model fuel, a temperature change of 18→41→18 degrees Celsius was made one cycle in a day, and the cycle was repeated three times. Then an amount of hydrocarbons having evaporated from the fuel tank in three days was measured, and thus the gasoline permeation amount was evaluated.

The gasoline permeation amount was evaluated as passed in a case of not more than 2 mg/day: the pass is represented by G; no pass by NG.

<Low Temperature Drop Test>

After having filled antifreeze in an obtained fuel tank full and having left it at −40 degrees Celsius not less than 24 hours, the tank was dropped on a concrete floor from a height of 6 m (n=5). An evaluation was made by having assumed it G a case of the fuel tank having not broken at all; and having assumed it NG a case of a slight breakage having been recognized.

<TIS>

Having sampled a test piece for measuring the TIS from two places of a flat portion of the obtained fuel tank and having measured the TIS (ASTM 1822) and the thickness of each resin layer by the same method as in the example 1, the EVOH thickness ratio was measured. The TIS was assumed to be passed if it was not less than 50 kJ/m².

<Evaluation Result of Gasoline Permeation Amount>

A measurement result of the gasoline permeation amount of fuel tanks regarding to the examples 3 to 5 and the comparison example 2 is shown in Table 2.

TABLE 2

| | Ethylene | Setting Value of | Gasoline | |
|---|---|---|---|---|
| | Containment | EVOH | Permeation | |
| | Amount | Thickness Ratio | Amount | |
| | (mol %) | (%) | (mg/day) | Evaluation |
| Example 3 | 24 | 2.5 | 1.8 | G |
| Example 4 | 24 | 3.2 | 1.9 | G |
| Example 5 | 24 | 4.5 | 1.5 | G |
| Comparison | 26 | 2.5 | 2.8 | NG |
| Example 2 | | | | |

As shown in Table 2, in the case of the ethylene containment amount of 26 mol % (comparison example 2) the good barrier property of the fuel permeation cannot be obtained. On the other hand, in the case of the ethylene containment amount of 26 mol % the good barrier property of the fuel permeation is recognized even if a setting value of the EVOH thickness ratio is not more than 5.0%. From this result and the result of Table 1, it is proved that the ethylene containment amount is needed to be not more than 25 mol %.

Meanwhile, when having measured the gasoline permeation amount of a fuel tank (ethylene containment amount, 36 mol %) composed of an HDPE and EVOH currently used by the same measurement method, the amount was 9 mg/day.

<Impact Test Result>

With respect to the cases (examples 3 to 5) of the ethylene containment amount of 24 mol %, the TIS and the low temperature drop test were performed. The result is shown in Table 3.

TABLE 3

| | | | Actually | | |
|---|---|---|---|---|---|
| | Ethylene | Setting Value | Measured | | |
| | Containment | of EVOH | Value of EVOH | | Low |
| | Amount | Thickness Ratio | Thickness Ratio | TIS | Temperature |
| | (mol %) | (%) | (%) | (kJ/m2) | Drop Test |
| Example 3 | 24 | 2.5 | 2.0 | 221 | G |
| | | | 2.2 | 218 | G |
| Example 4 | 24 | 3.2 | N.A. | N.A. | G |
| Example 5 | 24 | 4.5 | 3.7 | 201 | G |
| | | | 4.0 | 182 | G |

N.A.: Not Available

In any case a breakage of the fuel tank by the low temperature drop test was not recognized. In addition, also in the TIS measurement result any one is a value not less than 50 kJ/m2 and is proved to have practically no problem. Thus by making the EVOH thickness ratio 2.0 to 5.0%, it is proved that a fuel tank having an excellent impact strength can be obtained.

Furthermore, looking into the TIS measurement result in detail, if making the setting value of the EVOH thickness ratio 4.5%, there is a case that the actually measured value of the EVOH thickness ratio becomes 4.0% due to a difference of the blow-up ratio within the blow molding product, and at this time, it is proved that the TIS becomes smaller than 200 kJ/m². Accordingly, in a case of producing a large amount of fuel tanks, when variations of the impact strength are requested to be made smaller, the EVOH thickness ratio may be made 2.0 to 3.7%.

Thus, although the examples of the present invention are described, the invention is not limited thereto and various variations are available without departing from the spirit and scope of the invention.

What is claimed is:

1. A vehicle fuel tank molded with a laminated body of one or more kinds of resins, the laminated body comprising:
a barrier layer composed of an ethylene-vinyl alcohol copolymer, wherein an ethylene containment amount is 20 to 25 mol %; and
an outer layer and inner layer that are molded with a thermoplastic resin other than the ethylene-vinyl alcohol copolymer and provided at both faces of said barrier layer,
wherein said inner layer is located at a side contacting any of fuel and evaporated fuel, and a thickness of said barrier layer is 2.0 to 5.0% of a thickness of the laminated body of said one or more kinds of the resins.

2. A vehicle fuel tank according to claim 1, wherein a melt flow rate of said ethylene-vinyl alcohol copolymer is 0.1 to 10 g/10 min.

3. A vehicle fuel tank according to claim 1, wherein said thermoplastic resin is a high density polyethylene.

4. A vehicle fuel tank according to claim 1, wherein an adhesive resin layer is provided between said barrier layer and said inner layer and between said barrier layer and said outer layer.

5. A vehicle fuel tank according to claim 1, wherein a tensile impact strength at −40 degrees Celsius is not less than 50 kJ/m².

6. A vehicle fuel tank according to claim 1, wherein a thickness of said barrier layer is not less than 120 μm.

7. A vehicle fuel tank according to claim 1, wherein a gasoline permeation amount is not more than 2.0 mg/day.

8. A member of a vehicle fuel tank molded with a laminated body of one or more kinds of resins, the laminated body comprising:
a barrier layer composed of an ethylene-vinyl alcohol copolymer, wherein an ethylene containment amount is 20 to 25 mol %; and
an outer layer and inner layer that are molded with a thermoplastic resin other than the ethylene-vinyl alcohol copolymer and provided at both faces of said barrier layer,
wherein said inner layer is located at a side contacting any of fuel and evaporated fuel, and a thickness of said barrier layer is 2.0 to 5.0% of a thickness of the laminated body of said one or more kinds of the resins.

9. A member of a vehicle fuel tank according to claim 8, wherein a melt flow rate of said ethylene-vinyl alcohol copolymer is 0.1 to 10 g/10 min.

10. A member of a vehicle fuel tank according to claim 8, wherein said thermoplastic resin is a high density polyethylene.

11. A member of a vehicle fuel tank according to claim 8, wherein an adhesive resin layer is provided between said barrier layer and said inner layer and between said barrier layer and said outer layer.

12. A member of a vehicle fuel tank according to claim 1, wherein a tensile impact strength at −40 degrees Celsius is not less than 50 kJ/m².

13. A member of a vehicle fuel tank according to claim 8, wherein a thickness of said barrier layer is not less than 120 μm.

14. A member of a vehicle fuel tank according to claim 8, wherein a gasoline permeation amount is not more than 2.0 mg/day.
